(19) United States
(12) Patent Application Publication
(10) Pub. No.: US 2013/0312737 A1
(43) Pub. Date: Nov. 28, 2013

(54) Collapsible Grill

(71) Applicant: Kiosky CHUNG, (US)

(72) Inventor: Kiosky CHUNG, (US)

(21) Appl. No.: 13/481,767

(22) Filed: May 25, 2012

(51) Int. Cl. A47J 37/07; A47J 33/00

(52) U.S. Cl. 126/9 B; 126/25 R

(57) ABSTRACT

A collapsible grill includes two supporting elements. Each supporting element includes two lateral strips each including a first long edge and a second long edge, a major plate extending between the first long edges of the lateral strips, a minor plate extending between the second long edges of the lateral strips, and a rib extending thereon. Each lateral strip is pivotally connected to a respective lateral strip of the other supporting element. Thus, the collapsible grill is switchable between an extended position and a collapsed position. The ribs together close a space defined between the major plates when the collapsible grill is in the collapsed position. The major plates together form a V-shaped configuration when the collapsible grill is in the extended position.

### BACKGROUND OF INVENTION

1. Field of Invention

The present invention relates to a barbecue grill and, more particularly, to a collapsible grill.

2. Related Prior Art

A conventional grill includes a grid supported on a pan supported on legs placed on the ground for example. Coal is burned in the pan. Food is grilled on the grid. This conventional grill is not collapsible and hence not portable conveniently.

As disclosed in U. S. Patent Application Publication no. 2007084354, a collapsible grill includes on a supporting unit 2 for supporting a grid 3 and a pan 4. The supporting unit 2 includes two frames 21 and 22. Each frame includes a crossbar extending between two parallel legs. Each leg of the frame 21 is pivotally connected to a respective leg of the frame 22. Thus, supporting unit 2 is switched between an extended position and a collapsed position. Coal is burned in the pan 4 supported on the supporting unit 2 in the extended position. Food is grilled on the grid 3 supported on the supporting unit 2 in the extended position. The frames 21 and 22 are hollow so that the pan 4 is a necessary element for holding the coal. The pan 4 is however not collapsible and hence bulky for transportation.

As disclosed in China Patent Application Publication no. 200820088501.X, a collapsible grill includes a supporting unit and a grid 9. The supporting unit includes two plates 1 and 2 pivotally connected to each other, two legs 5 pivotally connected to the plate 2, and two legs 6 each pivotally connected to a respective leg 5. Thus, the supporting unit is switchable between an extended position and a collapsed position. Coal is burned on a V-shaped structure made of the plates 1 and 2 in the extended position. Food is grilled on the grid 9 supported on the supporting unit in the extended position. Each plate includes a slot 10 defined therein so that a portion thereof may be used like a handle when the supporting element is in the collapsed position. The slots 10 however reduce the areas of the plates 1 and 2. Hence, only a small amount of coal can be burned on the plates 1 and 2, and only a small grid 9 can be used.

The present invention is therefore intended to obviate or at least alleviate the problems encountered in prior art.

### SUMMARY OF INVENTION

It is an objective of the present invention to provide a collapsible grill that occupies a small amount of space when it is collapsed.

It is another objective of the present invention to provide a collapsible grill that supports a large grid when it is extended.

To achieve the foregoing objectives, the collapsible grill includes two supporting elements. Each supporting element includes two lateral strips each including a first long edge and a second long edge, a major plate extending between the first long edges of the lateral strips, a minor plate extending between the second long edges of the lateral strips, and a rib extending thereon. Each lateral strip is pivotally connected to a respective lateral strip of the other supporting element. Thus, the collapsible grill is switchable between an extended position and a collapsed position. The ribs together close a space defined between the major plates when the collapsible grill is in the collapsed position. The major plates together form a V-shaped configuration when the collapsible grill is in the extended position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a collapsible grill in an extended position according to the preferred embodiment of the present invention;

FIG. 2 is a perspective view of a first supporting element of the collapsible grill shown in FIG. 1;

FIG. 3 is a perspective view of a second supporting element of the collapsible grill shown in FIG. 1;

FIG. 4 is a cross-sectional view of the collapsible grill shown in FIG. 1;

FIG. 5 is a perspective view of the collapsible grill in a transient position other than the extended position shown in FIG. 1;

FIG. 6 is a cross-sectional view of the collapsible grill in a collapsed position other than the extended position shown in FIG. 1; and

FIG. 7 is a perspective view of the collapsible grill shown in FIG. 6.

### DETAILED DESCRIPTION OF PREFERRED EMBODIMENT

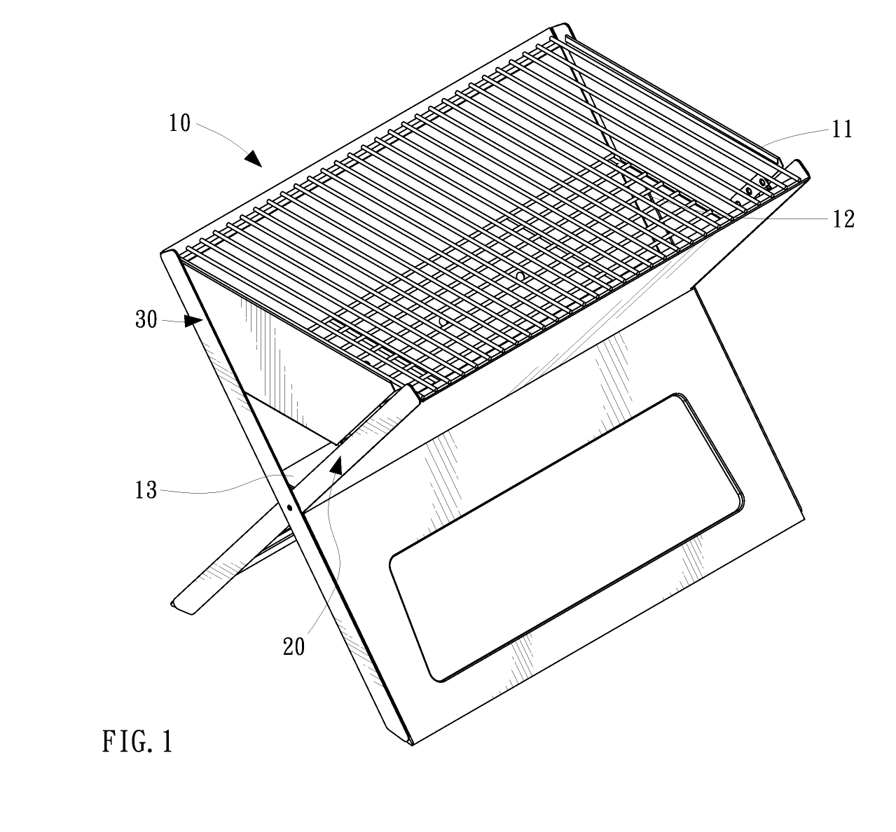

Referring to FIG. 1, there is shown a collapsible grill 10 in an extended position according to the preferred embodiment of the present invention. The collapsible grill 10 includes a food-supporting grid 11, a coal-supporting grid 12, a first supporting element 20 and a second supporting element 30. The area of the food-supporting grid 11 is larger than that of the coal-supporting grid 12. The grids 11 and 12 are supported on the supporting elements 20 and 30, with the food-supporting grid 11 placed above the coal-supporting grid 12. Food can be grilled on the food-supporting grid 11. Coal can be burned on the coal-supporting grid 12.

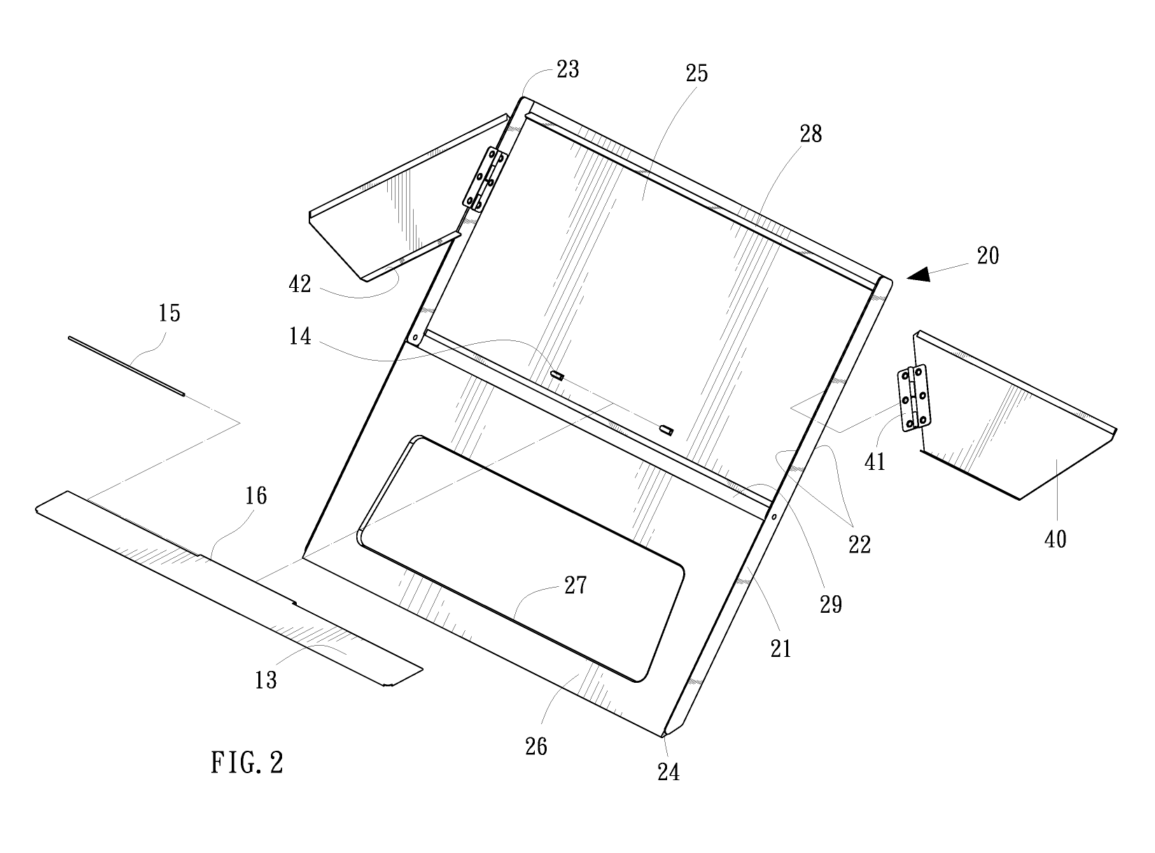

Referring to FIG. 2, the first supporting element 20 includes two lateral strips 21, a major plate 25 and a minor plate 26. The plates 25 and 26 extend between the lateral strips 21. Each lateral strip 21 includes two long edges 22, an upper short edge 23 and a lower short edge 24. The major plate 25 includes two lateral edges each connected to the first long edge 22 of a lateral respective lateral strip 21. A rib 28 is formed on the major plate 25 near an upper edge.

The minor plate 26 includes an opening 27 defined therein, a flange 44 extending around the opening 27, and a tab 45 extending from a portion of the flange 44. The minor plate 26 further includes two lateral edges each connected to the second long edge 22 of a respective lateral strip 21. Thus, a gap 29 is defined between a lower edge of the major plate 25 and an upper edge of the minor plate 26.

An ash tray 13 is formed with a tab that is turned into a roll 16. The ash tray 13 is pivotally connected to the major plate 25 by inserting an axle 15 in the roll 16 and two sleeves 14 formed on the major plate 25 in the vicinity of the lower edge.

There are two baffles 40 in the form of a trapezoid that includes two lateral edges extending between an upper edge and a lower edge. The short edge of each baffle 40 is bent to form a flange 42. A lateral edge of each baffle 40 is pivotally connected to a respective lateral strip 21 by a hinge 41.

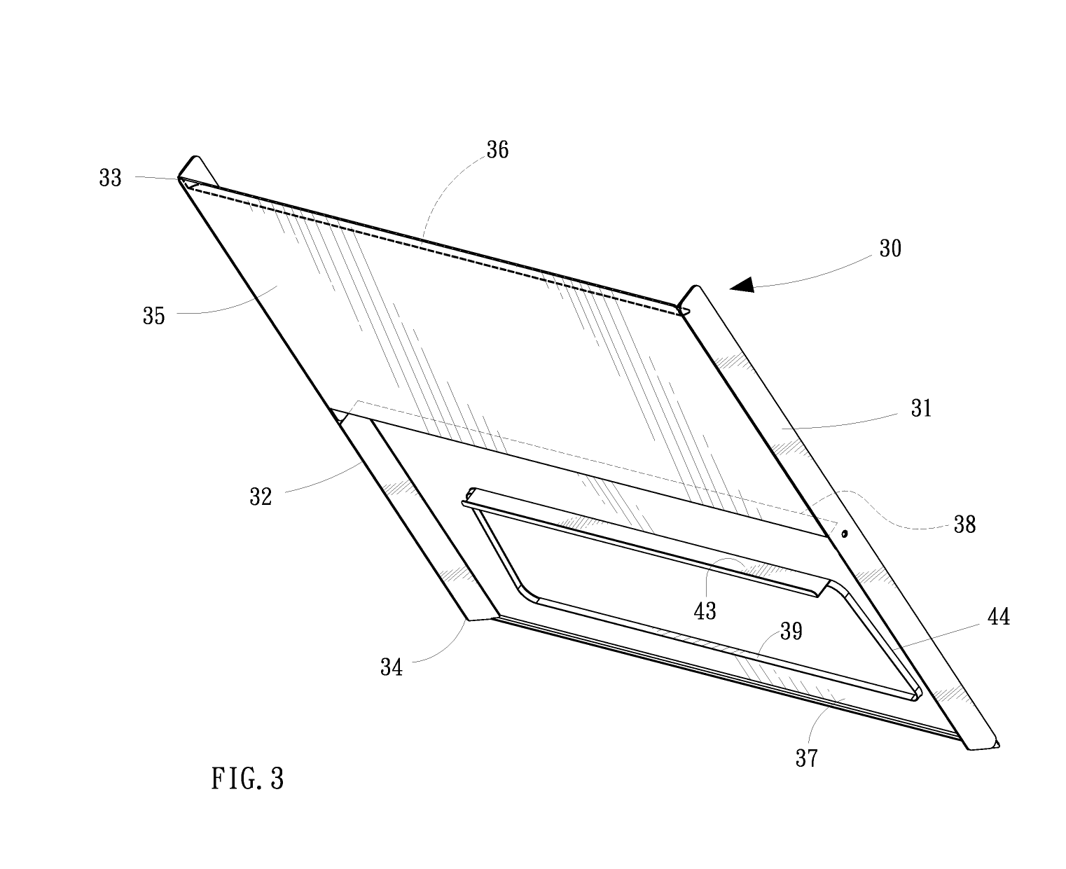

Referring to FIG. 3, the second supporting element 30 includes two lateral strips 31, a major plate 35 and a minor plate 37. The plates 35 and 37 extend between the lateral strips 31. Each lateral strip 31 includes two long edges 32, an upper short edge 33 and a lower short edge 34. The major plate 35 includes two lateral edges each connected to the first long edge 32 of a respective lateral strip 31. A rib 36 is formed on the major plate 35 near an upper edge.

The minor plate 37 includes an opening 39 defined therein, a flange 44 extending around the opening 39, and a tab 43 extending from a portion of the flange 44. The minor plate 37 includes two lateral edges each connected to the second long edge 32 of a respective lateral strip 31. Thus, a gap 38 is defined between a lower edge of the major plate 25 and an upper edge of the minor plate 26.

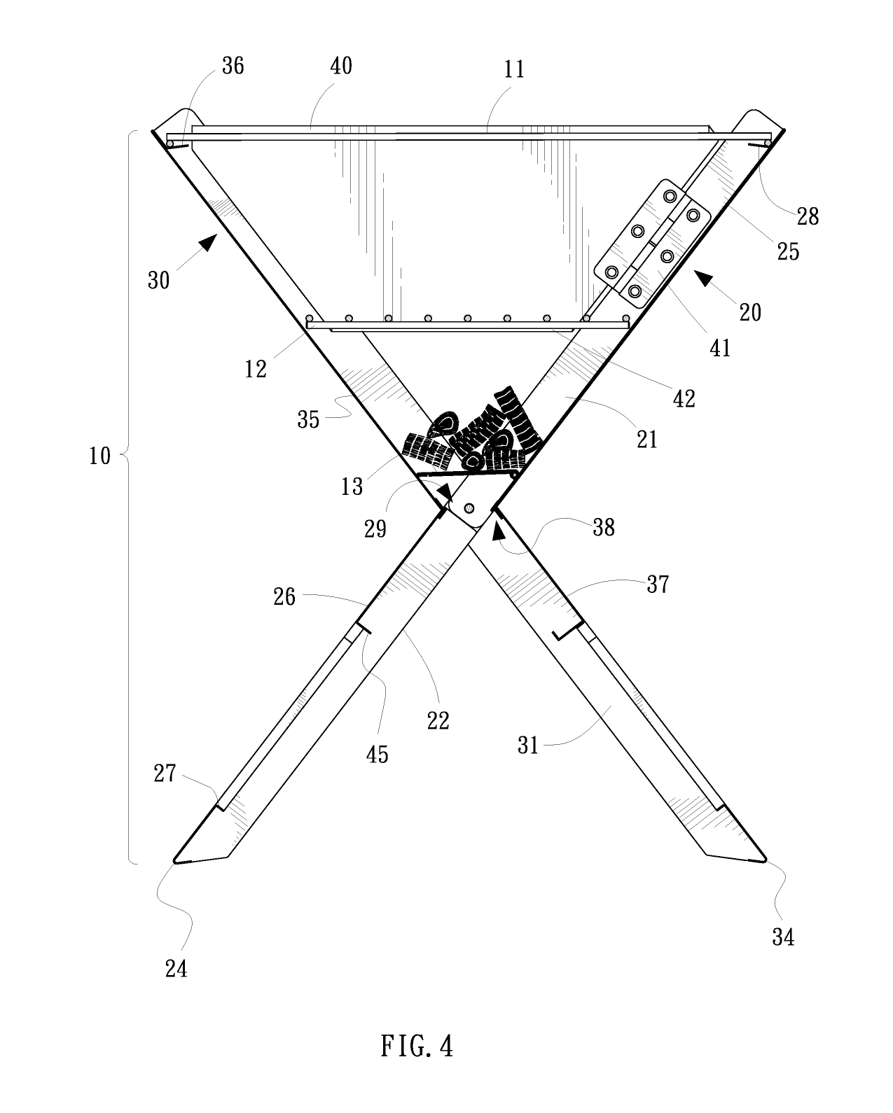

Referring to FIGS. 1 and 4, the first supporting element 20 is inserted in the gap 38 defined in the second supporting element 30. A middle portion of each lateral strip 21 is pivotally connected to middle portion of a respective lateral strip 31 by a pin, a screw or a rivet for example. The major plate 25 is supported on the upper edge of the minor plate 37 while the major plate 35 is supported on the upper edge of the minor plate 26. Thus, the supporting elements 20 and 30 are kept in the extended position. The major plates 25 and 35 form a V-shaped configuration. The lower short edges 24 of the lateral strips 21 and the lower short edges 34 of the lateral strips 31 are placed on the ground.

The ash tray 13 is in an extended position for receiving ash. The coal-supporting grid 12 is supported on the flanges 42. Coal can be burned on the coal-supporting grid 12. The baffles 40 are kept in the extended position by the coal-supporting grid 12. The food-supporting grid 11 is supported on the ribs 28 and 36.

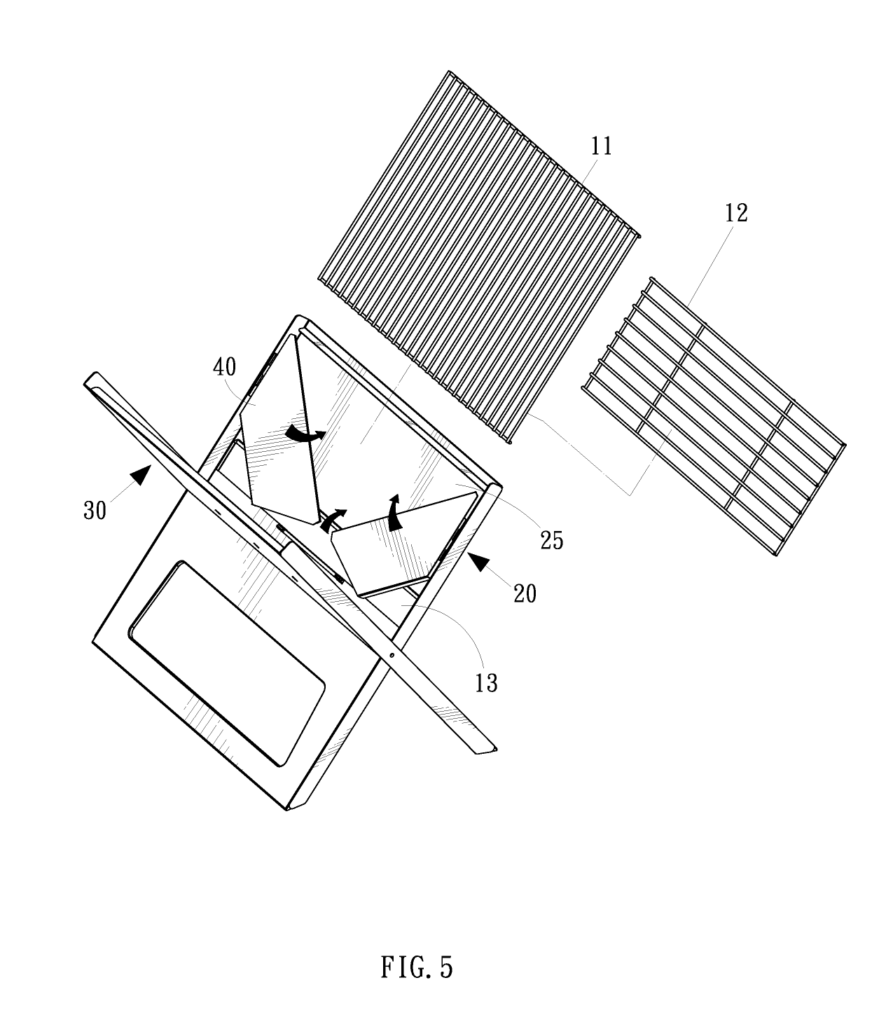

Referring to FIG. 5, the food-supporting grid 11 is removed from the ribs 28 and 36. The coal-supporting grid 12 is removed from the flanges 42, thus allowing pivoting of the baffles 40 to a collapsed position where they are placed against the major plate 25. The ash tray 13 is pivoted to a collapsed position where it is placed against the major plate 25. The ash tray 13 is collapsed before the baffles 40 are collapsed.

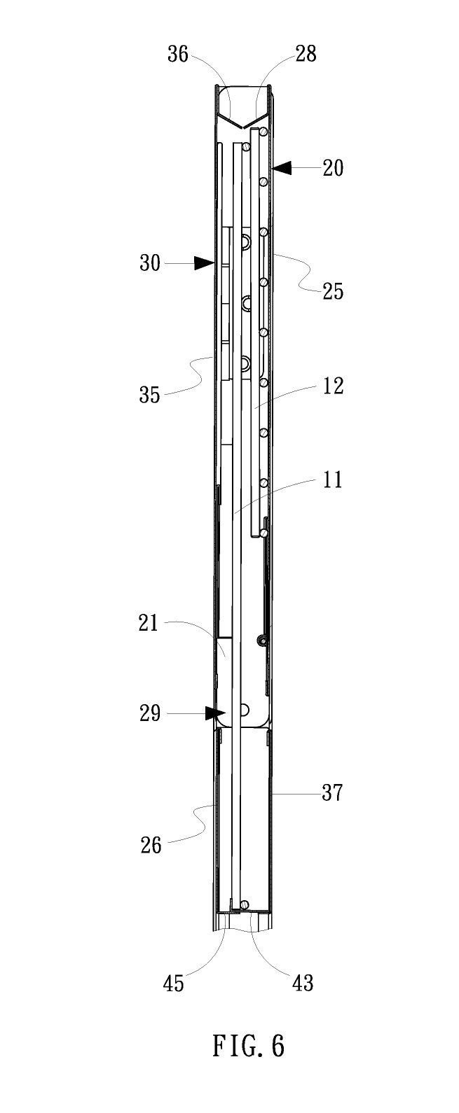

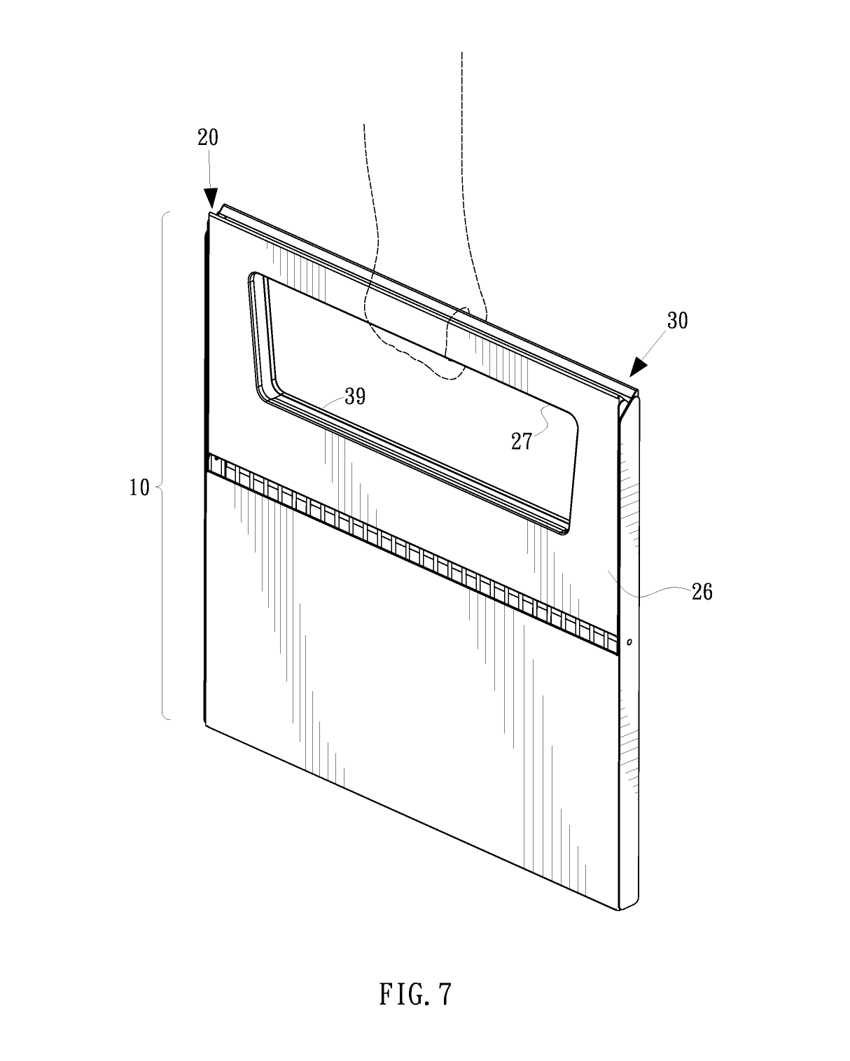

Referring to FIGS. 6 and 7, the supporting elements 20 and 30 are moved to a collapsed position where the major plate 25 is placed in the vicinity of the major plate 35 while the minor plate 26 is placed in the vicinity of the minor plate 37. The grids 11 and 12 are placed in a space defined between the major plates 25 and 35 of the supporting elements 20 and 30, respectively. The space is closed by the ribs 28 and 36. The opening 27 is aligned with the opening 39. Thus, a portion of the minor plate 26 and a portion of the minor plate 37 are used as handles to facilitate the transportation of the collapsible grill 10. The tab 43 is in frictional contact with the tab 45 to prevent the supporting elements 20 and 30 from switching to the extended position accidentally.

The collapsible grill 10 exhibits at least two advantageous features over the prior art. At first, it occupies a small amount of space when it is collapsed without using a pan for holding coal. Secondly, it supports a large grid when it is extended for making the openings 27 and 39 in the minor plates 26 and 37 instead of in the major plates 25 and 35.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A collapsible grill including two supporting elements, each including:
two lateral strips each including a first long edge and a second long edge, wherein each of the lateral strips is pivotally connected to a respective one of the lateral strips of the other supporting element so that the collapsible grill is switchable between an extended position and a collapsed position;
a major plate, extending between the first long edges, of the lateral strips;
a minor plate, extending between the second long edges, of the lateral strips; and
a rib extending thereon, wherein the ribs and together close a space defined between the major plates when the collapsible grill is in the collapsed position, wherein the major plates together form a V-shaped configuration when the collapsible grill is in the extended position.

2. The collapsible grill according to claim 1, including a food-supporting grid supported on the ribs when the collapsible grill is in the extended position, wherein the food-supporting grid is placed in the space defined between the major plates when the collapsible grill is in the collapsed position.

3. The collapsible grill according to claim 1, including a coal-supporting grid placed below the food-supporting grid when the collapsible grill is in the extended position, wherein the coal-supporting grid is placed in the space defined between the major plates when the collapsible grill is in the collapsed position.

4. The collapsible grill according to claim 3, including two baffles each including a flange extending from a lower edge, wherein the baffles are pivotally connected to one of the major plates, wherein the coal-supporting grid is supported on the flanges when the collapsible grill is in the extended position, wherein the baffles are placed in the space defined between the major plates when the collapsible grill is in the collapsed position.

5. The collapsible grill according to claim 4, wherein one of the supporting elements includes an ash tray pivotally connected to the major plate, wherein the ash tray is placed below the coal-supporting grid when the collapsible grill is in the extended position, wherein the ash tray is placed in the space defined between the major plates when the collapsible grill is in the collapsed position.

6. The collapsible grill according to claim wherein 1, each of the minor plates includes an opening defined therein.

7. The collapsible grill according to claim 6, wherein each of the minor plates includes a tab extending by the opening wherein the tabs are in frictional contact with each other to prevent accidental opening of the supporting elements.
